(19) United States
(12) Patent Application Publication
(10) Pub. No.: US 2013/0133206 A1
(43) Pub. Date: May 30, 2013

(54) Utensils With Raised Working End When Resting

(71) Applicant: KYLE DONOVAN, NEW YORK, NY (US)

(72) Inventor: KYLE DONOVAN, NEW YORK, NY (US)

(21) Appl. No.: 13/304,341

(22) Filed: Nov. 24, 2011

(51) Int. Cl. A47G 21/00; B26B 3/02; A47G 21/04; A47G 21/02

(52) U.S. Cl. 30/298.4; 30/340; 30/323; 30/327

(57) ABSTRACT

A utensil of embodiments of the disclosed technology has a curvilinear neck having a top and bottom side, a handle extending from the curvilinear neck, a working end adapted for placement within a mouth (of a person), the handle connected to the curvilinear neck and having a bottom side extending downwards past the bottom side of the curvilinear neck, a handle extending from the neck, and a post. A top of the post is connected to the bottom of the neck, and a bottom of the post, opposite the top of the post, extends downwards past the entire bottom side of the working end, such that a line drawn from an end of the handle (the end opposite the curvilinear neck) to a bottom of the post passes below the entire bottom side of the working end.

### BACKGROUND OF THE DISCLOSED TECHNOLOGY

The fork is a utensil used in the process of eating. The fork enables people to transport food from their plate or bowl to the mouth without touching the food with their fingers. Further, the fork is a tool used in cooking or helping to hold down foods being cut with a knife. The fork has a long history as an eating utensil, and it was initially used by the ancient Greeks. Later on, the fork was adopted by the Romans and its use slowly spread throughout western Europe. However, many Asian cultures developed the use of chopsticks, instead. The design of the fork has not changed much since it was invented thousands of years ago. Initially, forks were designed with two prongs, but eventually forks were produced with three or four prongs.

One of the main reasons for using a fork is to enable a person to eat food without touching it. This is for aesthetic as well as sanitary reasons. People were, and still are, concerned about the cleanliness of their food. Since our hands touch many objects during our daily activities, a substitute had to be developed which allows a person to avoid touching the food with his or her hands. By using a utensil, whether it be a fork, knife, spoon, or chopstick, one avoids transferring bacteria, pathogens, and dirt from one's hand to one's food before ingesting it.

Although people use forks to protect their food from contamination by bacteria, now that more is known about the presence of bacteria and their deleterious effect on people's health, such preventive measures are of limited effectiveness when the tool is rested on areas full of bacteria, such as restaurant table tops, home kitchens, and the like, where, unfortunately, bacteria abound. For example, many restaurants place eating utensils on bare tabletops which are rife with to bacteria. Some restaurants wrap the eating utensils in paper napkins so as to avoid their contact with the tabletop, but such a remedy becomes futile once customers unwrap the eating utensils and let any of them touch the surface of the table, during the course of the meal. Some restaurants try to keep their table tops clean by spraying them with various chemical agents, but this solution could pose a risk of the fork being exposed to such chemicals when it comes into contact with the table top. Consequently, a solution is needed in order to keep the forks as clean as possible and bacteria free.

### SUMMARY OF THE DISCLOSED TECHNOLOGY

An eating utensil of the disclosed technology has a working end, a curvilinear handle, and a neck between the curvilinear handle and the working end. A post extends from the neck substantially (within a 15 degree tolerance level) perpendicularly to the working end of the utensil. A bottom side of the utensil may be defined by a convex side of the working end. As such, when the utensil is resting on a flat surface on the bottom side, the working end is raised above the flat surface. Still further, an extreme end of the curvilinear handle opposite the working end may rest on a surface; when doing so, the base of the post rests on the surface, while the working end remains elevated. The angle of the post may be perpendicular to the angle of resting of the working end of the utensil and parallel to the base of the utensil.

In another embodiment, a utensil has a handle with a first end and oppositely disposed second end, the second end forming a unitary structure with a neck region. The neck region has a post. A working end is adapted for contact with food and is connected unitarily to the neck. The first end of the handle and the post are beneath the working end, such that the first end of the handle and the post touch a flat surface, and the rest of the utensil, including the working end and neck, is held above the surface.

The post may have a hollow interior adapted to engage an exterior of a post of a second similar or exact replica of the utensil, such that the utensils may stack, one atop another, held in place by the stacked posts. The utensil(s) may be a fork, knife, or spoon, or even a chop stick.

A utensil of embodiments of the disclosed technology has a curvilinear neck having a top and bottom side, a handle extending from the curvilinear neck, a working end adapted for placement within a mouth (of a person), the handle connected to the curvilinear neck and having a bottom side extending downwards past the bottom side of the curvilinear neck, a handle extending from the neck, and a post. A top of the post is connected to the bottom of the neck, and a bottom of the post, opposite the top of the post, extends downwards past the entire bottom side of the working end, such that an imaginary line drawn from an end of the handle (the end opposite the curvilinear neck) to a bottom of the post passes below the entire bottom side of the working end. This “imaginary line” may be a surface on which the utensil rests.

### BRIEF DESCRIPTION OF THE DRAWINGS

FIG. 1 shows a top perspective view of a fork with a post of embodiments of the disclosed technology.

FIG. 2 shows a bottom perspective view of the fork of FIG. 1.

FIG. 3 shows a side elevation view of the fork of FIG. 1.

FIG. 4 shows a top plan view of the fork of FIG. 1.

FIG. 5 shows a top perspective view of a spoon with post of embodiments of the disclosed technology.

FIG. 6 shows a side elevation view of the spoon of FIG. 5.

FIG. 7 shows a top plan view of a knife of embodiments of the disclosed technology.

FIG. 8 shows a top perspective view of the knife of FIG. 7.

FIG. 9 shows a side perspective view of a chop stick with post of an embodiment of the disclosed technology.

FIG. 10 shows an end view of the chop stick of FIG. 9.

### DETAILED DESCRIPTION OF EMBODIMENTS OF THE DISCLOSED TECHNOLOGY

The presently disclosed technology is directed towards a utensil with a post designed to keep the working end of the utensil, including a tip, a base thereof, as well as a majority of a handle from touching a resting surface on which the utensil is placed. The post is placed on the neck of the fork and extends downwards, past a lower end of a handle, as well as the base of the working end of the utensil. As a result, adding a post to a utensil, such as a fork, knife, spoon, or chopstick, allows the portion of the utensil which enters a person's mouth, and in some cases, the portion which touches a person's hand, to avoid contact with surfaces or other objects. Consequently, such a utensil of embodiments of the disclosed technology is less prone to bacteria build-up than commonly used forks.

(In this disclosure/claims, “top side” refers to the side of the utensil that faces upwards when such a utensil is placed on a table, as known in the art. “Bottom side”, “back side”, or “rear side” refers to the side that rests on the table, as known in the art.)

Embodiments of the disclosed technology will become clearer in view of the following description of the figures.

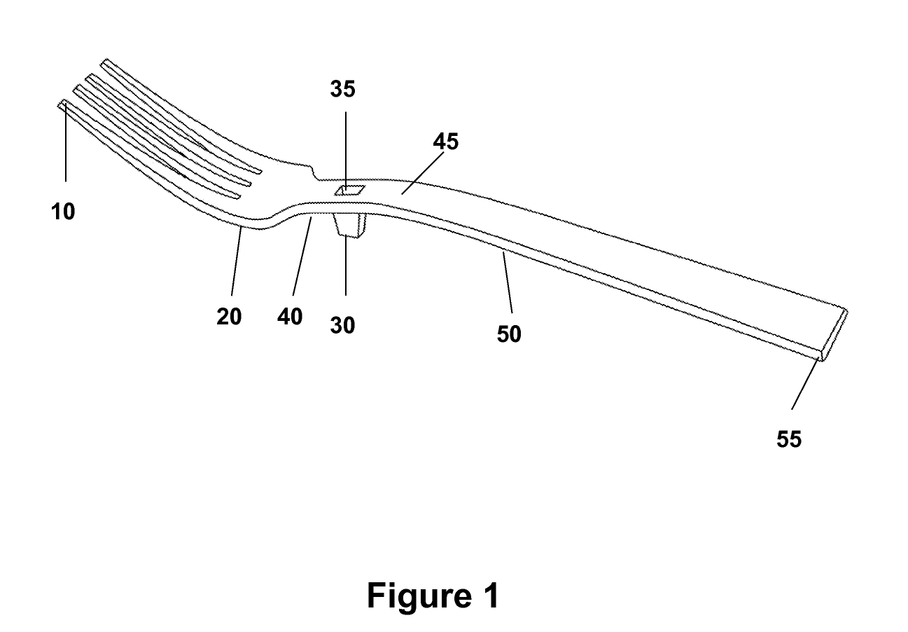

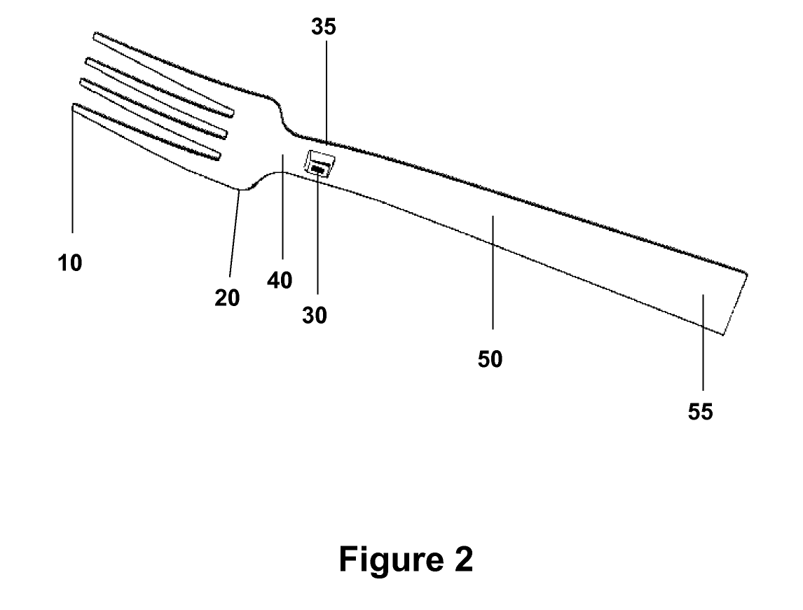

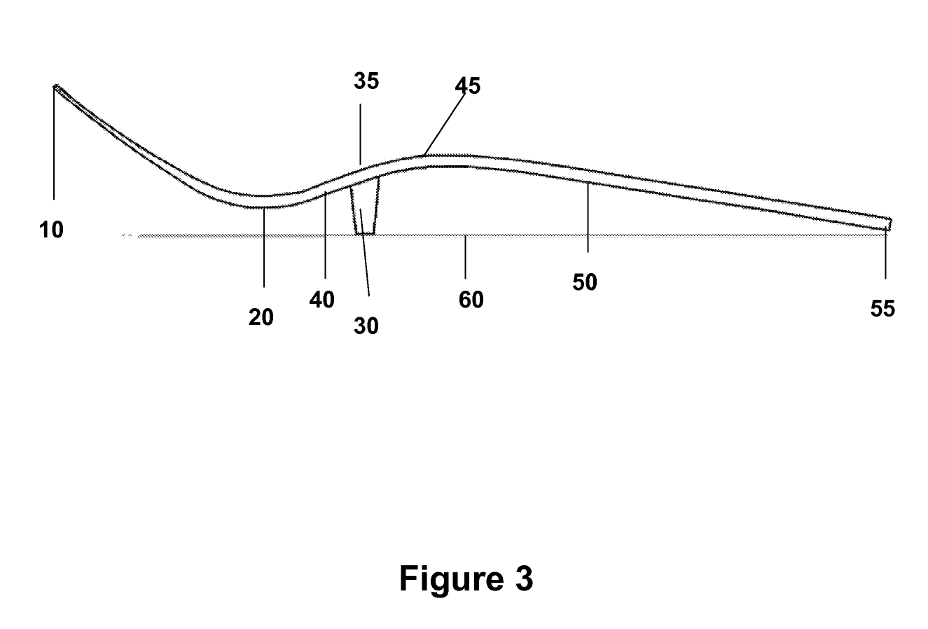

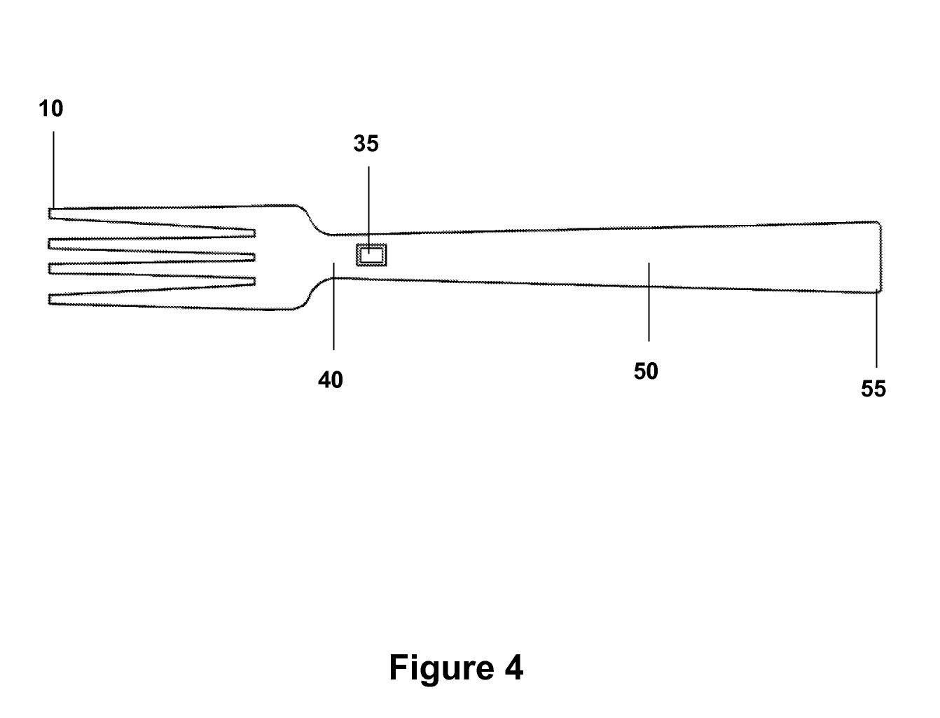

FIG. 1 shows a top perspective view of a fork with a post of embodiments of the disclosed technology. FIG. 2 shows a bottom perspective view of the fork of FIG. 1. FIG. 3 shows a side elevation view of the fork of FIG. 1. FIG. 4 shows a top plan view of the fork of FIG. 1. Referring to FIGS. 1-4 concurrently, the figures show views of a fork with a post 30 of embodiments of the disclosed technology. The fork has a working end 10 which is defined as a portion of a utensil that is in contact with food during use thereof. The working end 10 may also be the only portion of the utensil which enters or touches a person's mouth, in an embodiment of the disclosed technology, such as when the utensil is a spoon or a fork. As shown in FIG. 1, the utensil is a fork comprising four prongs. In other embodiments, the fork may comprise two or three prongs; in the case of a chopstick, there is a single ‘prong’ of the working end. As shown in later figures, if the utensil is a spoon, the working end 10 comprises a scoop.

Further, the utensil has a handle 50. The definition of a handle 50 is the portion of the utensil which is designed for gripping, holding, or other grasped engagement with the hand of a user. In embodiments, the handle 50 of the utensil is curved, such that an end of the handle 55 is at a low point (relative to a back of the handle). In other embodiments, the handle is straight. The handle 50 is located between the extreme end 55 and neck 40 of the utensil. The extreme end 55 of the utensil of embodiments of the disclosed technology is defined as the only point on a curved or straight handle 50 of the utensil that comes into contact with the imaginary line 60.

A neck 40 is defined as the portion of the utensil that is located between the working end 10 and the handle 50 and connects the two. The neck is further negatively defined as the portion which is not designed for gripping or contact with food during ordinary use. As such, neither food nor a person comes in regular or purposeful contact with the neck 40.

Referring again to the working end of the utensil, the working end 10 comprises a base 20 defined as the lowest portion thereof, with respect to the ground or a table surface 60, as shown in FIG. 3. That is, the base 20 is closest to the line 60, on the underside of the utensil when the utensil is resting in the orientation shown in FIG. 3. FIG. 2, again, shows the rear side of a utensil of an embodiment of the disclosed technology. The base 20 of the utensil of the embodiment of the disclosed technology does not touch, or come into contact with, a table surface 60, which may also be described as an imaginary line 60 extending from the base of the extreme end of the handle 55 to the bottom of a post 30.

Now describing the post 30 in more detail, the post of the utensil is defined as a structure that extends downward from the neck region 40, substantially perpendicular to an elongated side of the working end 10 of the utensil. That is, “substantially perpendicular” is defined as perpendicular to a general direction of the elongated portion of the utensil, according to a casual observer thereof. The post 30 rests on a surface or imaginary line 60, such that the bottom of the post is parallel to the extreme end 55 of the utensil. As such, the post 30 extends below the working end 10 of the utensil, including its lowest point at the base 20, thereby maintaining the working end of the utensil, in its entirety, above the surface 60 when the handle 50 (at the end 55) and the post 30 rest on a surface 60. As such, the working end 10, including its base 20, is less prone to bacteria build up. Further, in such a resting position, the neck 40 is also above the surface 60.

In embodiments of the disclosed technology, referring especially to FIG. 1, the post 30 comprises a hollow interior 35. This hollow interior allows for stacking of a plurality of such utensils in a more stable way than utensils known in the prior art which lack such posts. Furthermore, the said post 30 of embodiments of the disclosed technology may keep the working ends 10 of utensils from touching or contacting each other when stacked, which is beneficial, for example, to restaurants where each utensil has been used by a different person. The separation of working ends 10 from each other and from surfaces 60 prevents the spread of disease and bacteria from one utensil to another, and from a surface to working ends of utensils. The post 30 and the extreme end 55 of the utensil are the only points of the utensil that come into contact with a surface 60 when the post is rested on the surface 60.

Referring again specifically to FIG. 3, surface 60, or an imaginary line between the base of the handle 55 and post 30, defines a horizontal surface area that the utensil of embodiments of the disclosed technology is placed or rested on. Put in another way, the post 30 which extends downward from the neck 40 and the extreme end 55 of the utensil are the only two portions of said utensil that come into contact with the imaginary line 60. Everything forward of the post 30 is above the imaginary line 60, such that these portions of the utensil are lifted in the air when the device is rested, and do not come in contact with other objects. The weight of the utensil rests entirely on the bottom of post 30 and the extreme end of the handle 55, and the post 30 forms a fulcrum between the two sides, with utensil being weighted such that the handle side 50 is angled to the ground, keeping the other side (including the working end 10) in the air.

Referring now more specifically to FIGS. 1 and 3, an upper extremity 45 of the handle is marked. For purposes of this disclosure, this point is defined as the end of the neck 40 of a utensil with a curvilinear handle/neck, and beginning of the handle portion 50. As is known in the art, forks and spoons often have curved handles, like the arched back of a person. Point 20 refers to the lowest point of the curve (on the working end 10 of the utensil), point 40 refers to the tangential point where the curve is mid-angle where curvature stops or begins to reverse angle, point 45 is the top of the curve and high point of the segment of the utensil between point 20 and extreme end 55. At point 45, the utensil curves downwards again. The post 30 is placed between points 40 and 45 in embodiments of the disclosed technology. That is, the post is placed at the most forward point which will not interfere with the use of the utensil, also having the benefit of requiring the least amount of material in the post. This position is between the working end 10, the base (low point) 20 of the working end, and the high point/start of the handle 45.

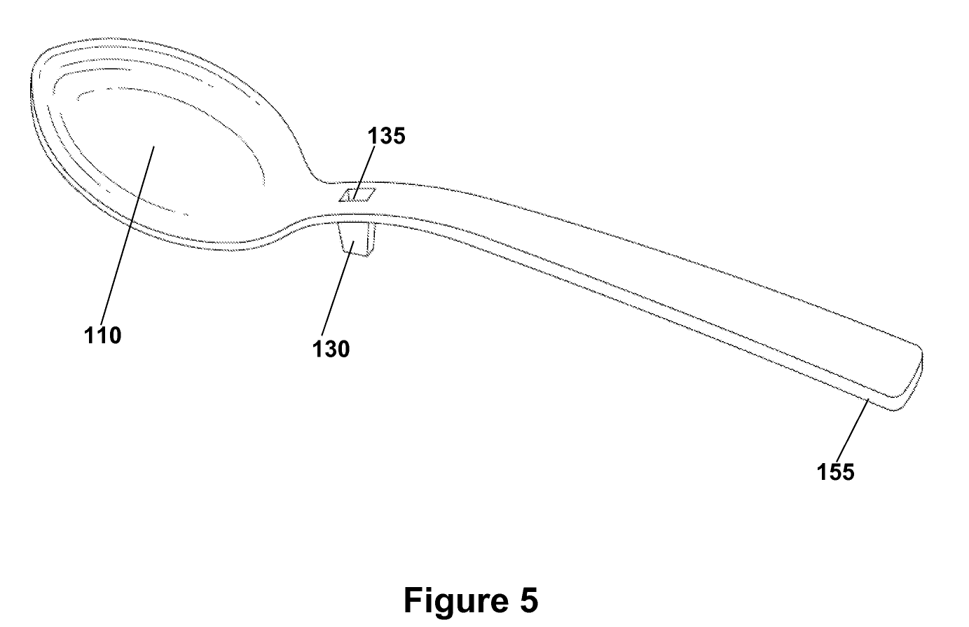

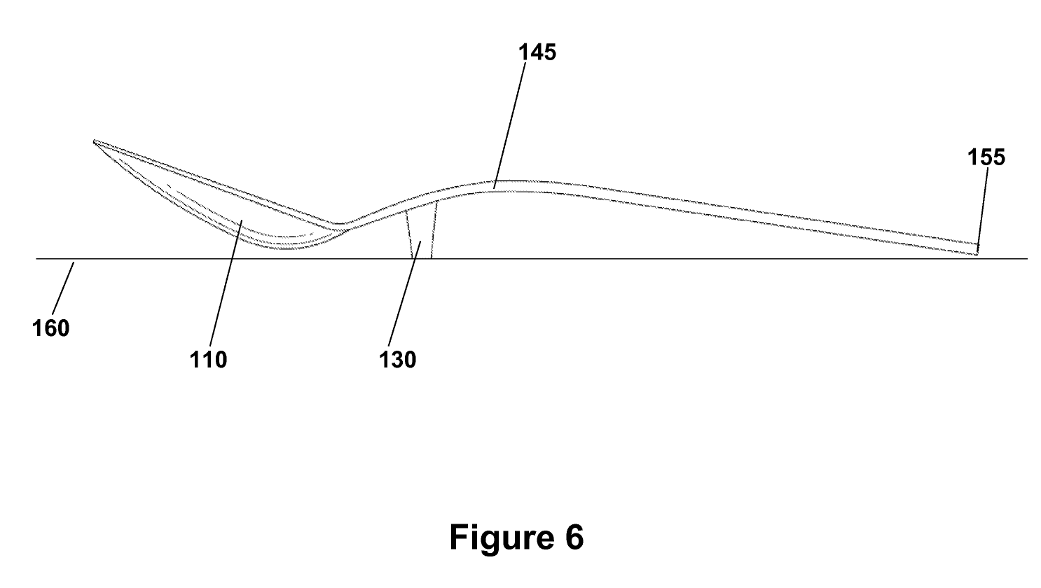

FIG. 5 shows a top perspective view of a spoon with post of embodiments of the disclosed technology. Elements of FIGS. 1-4 have been incremented by 100, where analogous in FIGS. 5 and 6. Here, working end 110 is a cup-shaped spoon. Post 130 with optional hollow stacking point 135 is on the neck portion, the neck integrated with a handle ending at the extreme end 155. It should be understood that the post is shown rectangular, but any shaped post is within the scope and spirit of the disclosed technology, including Square, circle, semi-circle, letter-A shaped, diamond, oval, tricuspoid, pear, triangle, rectangle, heart, marquise, bevel, or trapezoid.

FIG. 6 shows a side elevation view of the spoon of FIG. 5. Note that, when resting on a table or the ground 160 (any flat surface), working end 110 of the spoon is off the ground and the post 130 is situated on the neck, between the high point of the handle 145 and the working end which starts at the cup-shaped spoon, in this embodiment. Note the top of the post 130 is curved to accommodate the curvature of the neck of the spoon, while the bottom is flat (or angled compared to the curvature of the spoon's neck). In this manner, the utensil is angled when resting on surface 160, similar to if it were resting on the ground by way of the working end, but raised up enough to keep the working end from contact with any surface.

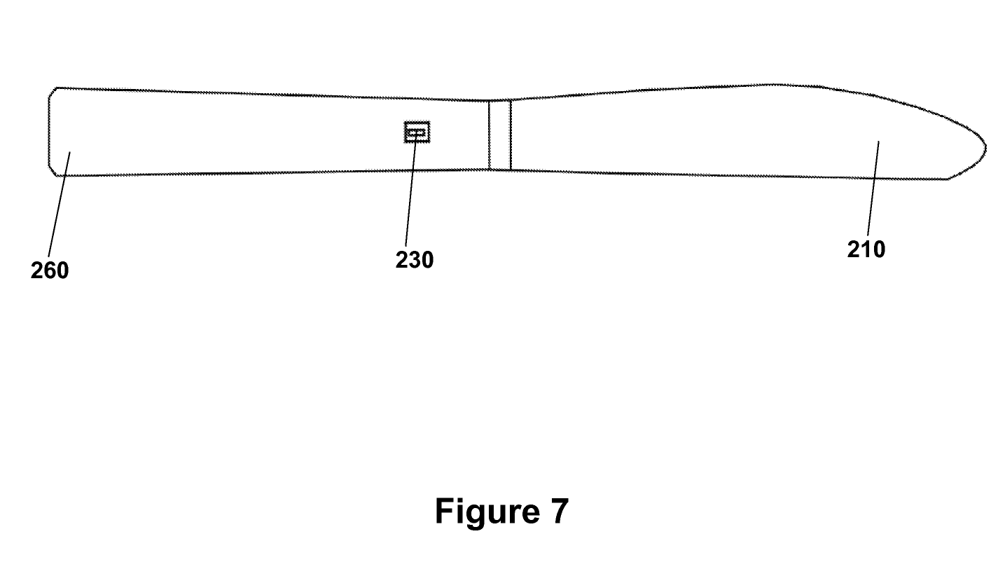

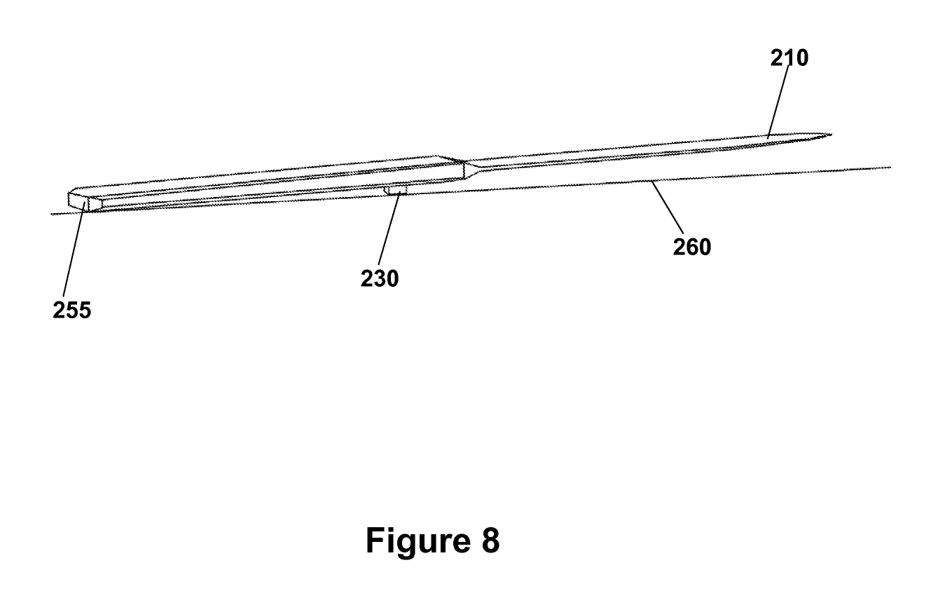

FIG. 7 shows a top plan view of a knife of embodiments of the disclosed technology. FIG. 8 shows a top perspective view of the knife of FIG. 7. Elements of the knife which are analogous to prior figures are incremented by multiples of 100. Thus, the knife has a working end 210, post 230, and extreme end of a handle 255. When resting, the working end 210 remains above a surface 260.

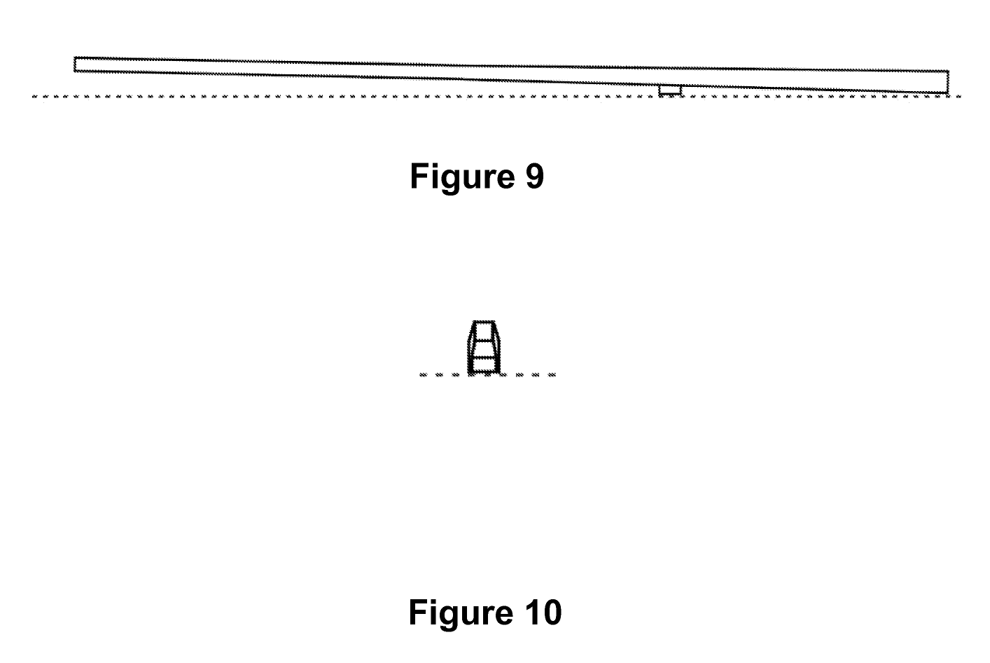

FIG. 9 shows a side perspective view of a chop stick with post of an embodiment of the disclosed technology. FIG. 10 shows an end view of the chop stick of FIG. 9.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. An eating utensil comprising:
a working end;
a curvilinear handle;
a neck between said curvilinear handle and said working end;
wherein a post extends from said neck substantially perpendicularly to said working end of said utensil.

2. The eating utensil of claim 1, wherein a bottom side of said utensil is defined by a convex side of said working end, and when said utensil is resting on a flat surface on said bottom side, said working end is raised above said flat surface.

3. The eating utensil of claim 1, wherein said post is perpendicular to
the angle of resting of said working end of said utensil and is parallel to the base of said utensil.

4. A utensil comprising:
a handle with a first end and oppositely disposed second end, said second end forming a unitary structure with a neck region;
said neck region comprising a post;
a working end adapted for contact with food connected unitarily to said neck;
wherein said first end of said handle and said post are beneath said working end, said neck, and said second end of said handle when said post and said first end of said handle are in contact with a flat surface.

5. The utensil of claim 4, wherein said post comprises a hollow interior adapted to engage an exterior of a post of a second utensil, said second utensil being identical to said utensil of claim 4.

6. The utensil of claim 4, wherein said utensil of claim 4 and said second utensil are stacked, such that said second utensil rests on said first utensil, and said first utensil rests on a surface.

7. The utensil of claim 4, wherein said utensil is a fork comprising at least three prongs.

8. The utensil of claim 4, wherein said utensil is a knife.

9. The utensil of claim 4, wherein said utensil is a spoon and said working end comprises a concave scoop, a convex side of said scoop being on a side of said utensil where said post extends from said neck.

10. A utensil comprising:
a curvilinear neck having a top and bottom side;
a handle extending from said curvilinear neck;
a working end adapted for placement within a mouth, connected to said curvilinear neck, comprising a bottom side extending downwards past said bottom side of said curvilinear neck;
a handle extending from said neck;
a post, wherein a top of said post is connected to said bottom of said neck and a bottom of said post, opposite said top of said post, extends downwards past the entire said bottom side of said working end, such that an imaginary line drawn from an end of said handle opposite said curvilinear neck to a bottom of said post passes below said entire said bottom side of said working end.

11. The utensil of claim 10, wherein said working end comprises a scoop of a spoon and said bottom side of said working end is a convex portion of said scoop.

12. The utensil of claim 10, wherein said working end comprises a fork.

13. The utensil of claim 10, wherein said post is hollow.

14. The utensil of claim 13, wherein said outer portion of said post is sized to fit within an inner portion of another said post.

15. The utensil of claim 10, wherein a resting surface corresponds to said imaginary line.
